(19) United States
(12) Patent Application Publication
(10) Pub. No.: US 2014/0310488 A1
(43) Pub. Date: Oct. 16, 2014

(54) Logical Unit Management using Differencing

(71) Applicant: TRANSPARENT IO, INC., Woodinville, WA (US)

(72) Inventor: John Aaron Strange, Ft. Collins, CO (US)

(73) Assignee: Transparent IO, Inc., Woodinville, WA (US)

(21) Appl. No.: 13/861,357

(22) Filed: Apr. 11, 2013

(51) Int. Cl. G06F 3/06

(52) U.S. Cl. CPC G06F 3/0667; G06F 3/067; G06F 3/0607
USPC 711/162

(57) ABSTRACT

A storage system may manage a logical unit using a differencing mechanism that captures changes to a base version of the logical unit. The logical unit may be presented to an operating system as a single storage device, while the logical unit may actually be provided by several storage devices that operate in conjunction with each other. In some cases, a single base version of the logical unit may be used to simultaneously provide multiple logical units, each of the logical units having a separate and independent differencing portion. In one such embodiment, a common base extent may contain read only versions of file blocks while each logical unit may contain independent differencing extents that contain changes to the base extent.

### BACKGROUND

Differencing is a mechanism by which two states of a storage system may be maintained. An original or older state may be stored without changing, and a differencing file may contain all of the changes to the older state. Differencing mechanisms may be used in backup operations as part of a snapshot mechanism to back up a file system or storage device while still servicing read and write requests to the device.

### SUMMARY

A storage system may manage a logical unit using a differencing mechanism that captures changes to a base version of the logical unit. The logical unit may be presented to an operating system as a single storage device, while the logical unit may actually be provided by several storage devices that operate in conjunction with each other. In some cases, a single base version of the logical unit may be used to simultaneously provide multiple logical units, each of the logical units having a separate and independent differencing portion. In one such embodiment, a common base extent may contain read only versions of file blocks while each logical unit may contain independent differencing extents that contain changes to the base extent.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a shared base image.

FIG. 2 is a diagram illustration of an embodiment showing a network environment with multiple logical units.

FIG. 3 is a flowchart illustration of an embodiment showing a method for configuring a logical unit.

FIG. 4 is a flowchart illustration of an embodiment showing a method for processing a write request.

FIG. 5 is a flowchart illustration of an embodiment showing a method for processing a read request.

### DETAILED DESCRIPTION

A storage management system may manage a logical unit using a differencing mechanism. The logical unit may be exposed to an operating system using a base version that is read only and a differencing mechanism that may capture all writes to the base version. The operating system may interact with the logical unit as if the logical unit were a single storage device. In many cases, an operating system may have a file system that stores data and executable code on the logical unit as files.

The logical unit may be provided from multiple storage devices and the configuration and behavior of the logical unit may be defined in a service level agreement. In many cases, the service level agreement may define that certain data may be replicated on multiple devices or may be placed on devices that meet certain performance minimums.

The storage management system may create a logical unit by creating and managing block extents on different devices. A block extent may be a portion of a storage device, such as a disk drive or solid state memory device, where the portion may be defined as a group of storage blocks.

The differencing mechanism may allow multiple logical units to be provided using a common block extent. The common block extent may be a base extent that is read only, while each logical unit may have a differencing mechanism that captures changes to the block extent. In practice, logical units that may have relatively small changes from a larger base extent may be delivered while consuming less storage media than multiple copies of the entire logical unit.

In one use scenario, the differencing mechanism may be useful in managing logical units in a datacenter environment. In many datacenter scenarios, a virtual machine or other workload may be transferred from one server to another. Often, workloads may be moved for load balancing or other reasons. When the workloads share a common base extent, a base extent may be present on two different servers. In order to move the workload from one server to another, a datacenter management system may merely move the differencing extent from one server to another, then recreate the logical unit on the destination server using the common base extent.

The storage management system may store blocks of data on multiple storage devices, including remote or network connected storage devices. In a normal operation, the remote storage device may be configured for write operations that are performed synchronously or asynchronously with local or other storage devices. Such a configuration may be operated within a service level agreement.

In many cases, at least one of the storage devices in a storage system may be a network connected or remote storage device. The remote storage device may provide redundancy in the case of a failure of a local device or system.

A storage management system may present a single logical unit while providing the logical unit on multiple devices. The logical unit may be made up of base images and differencing images that may each be stored on different groups of devices. The storage management system may maintain a service level agreement by configuring the devices in different manners and placing blocks of data on different devices.

The storage management system may manage storage devices that may include direct attached storage devices, such as hard disk drives connected through various interfaces, solid state disk drives, volatile memory storage, and other media including optical storage and other magnetic storage media. The storage devices may also include storage available over a network, including network attached storage, storage area networks, and other storage devices accessed over a network.

Each storage device may be characterized using parameters similar to or derivable from a service level agreement. The device characterizations may be used to select and deploy devices to create logical units, as well as to modify the devices supporting an existing logical unit after deployment.

The service level agreement may define certain parameters that may be applied to storage blocks having the same characteristics. Such a system may allow certain types of blocks to have different service level parameters than other blocks.

The service level agreement may identify minimum performance characteristics or other parameters that may be used to configure and manage a logical unit. The service level agreement may include performance metrics, such as number of input/output operations per unit time, latency of operations, bandwidth or throughput of operations, and other performance metrics. In some cases, a service level agreement may include optimizing parameters, such as preferring devices having lower cost or lower power consumption than other devices.

The service level agreement may include replication criteria, which may define a minimum number of different devices to store a given block. The replication criteria may identify certain types of storage devices to include or exclude.

The storage management system may receive a desired size of a logical unit along with a desired service level agreement. The storage management system may identify a group of available devices that may meet the service level agreement and provision the logical unit using the available devices.

During operation of the logical unit, the storage management system may identify when the service level agreement may be exceeded. The storage management system may reconfigure the provisioned devices in many different manners, for example by converting from synchronous to asynchronous write operations or striping read operations. In some cases, the storage management system may add or remove devices from supporting the logical unit, as well as moving blocks from one device to another to increase performance or otherwise meet the storage level agreement.

The service level agreement may define different parameters for a base image than a differencing image. For example, a base image may have a service level agreement that causes the base image to be stored in an archival storage with a copy on a local or other storage device with fast access times. The service level agreement may permit asynchronous copies of the base image to be made. Continuing with the example, a differencing image may have a storage level agreement that may cause the differencing image to be stored with synchronous copies, one of which may be on a remote system.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

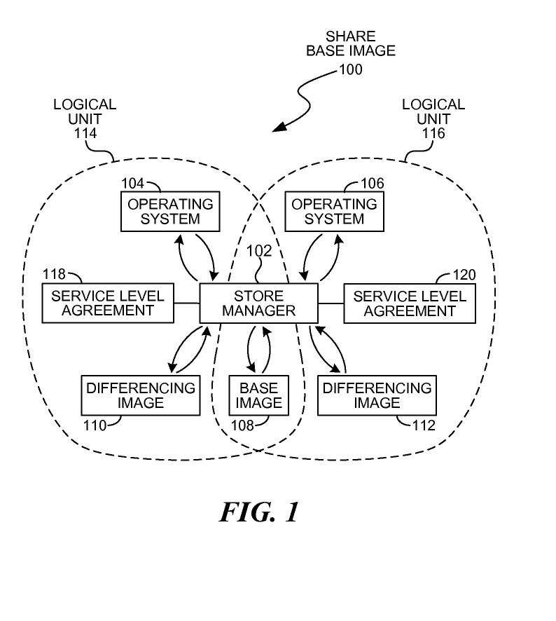

FIG. 1 is a diagram of an embodiment 100 showing a storage manager 102 that may manage multiple logical units from a single base image 108. Embodiment 100 is a concept level overview of a system that may present multiple logical units from a single base unit.

A storage manager 102 may present two logical units, one to each operating system 104 and 106. The logical unit 114 presented to operating system 104 may be created from a base image 108 and a differencing image 110. Similarly, the logical unit 116 presented to operating system 106 may be created from the same base image 108 and a different differencing image 112.

The main or base image 108 may be used for read requests but not for write requests. A write request may, by definition, attempt to change or alter the base image 108, and write requests may be stored in a differencing image.

When a read request is received, the read request may be serviced from a differencing image when the requested block has been altered from the base image. When the requested block has not been changed, the read request may be serviced from a base image 108.

Embodiment 100 illustrates one example of two logical units that may be created from a single base image. In one use scenario, a device with a hypervisor may host several guest operating systems as virtual machines. Rather than having a separate copy of an entire logical unit image for each of the guest operating systems, a storage manager 102 may have one base image 108 and a differencing image for each of the guest operating systems. Such a scenario may save a considerable amount of storage space, especially in a scenario where each of the virtual machines are very similarly configured.

In such a use scenario, the virtual machines may be managed by managing only the differencing image associated with the logical unit presented to the virtual machine. For example, backing up the logical unit associated with the virtual machine may involve storing only the differencing image and not the entire logical unit.

In many cases, a storage manager 102 may apply service level agreements for each logical unit. In some embodiments, each logical unit may have its own service level agreement. For example, logical unit 114 may have service level agreement 118 while logical unit 116 may have service level agreement 120.

A service level agreement may define one set of parameters for a base image and a different set of parameters for a differencing image.

The storage manager 102 may apply the respective service level agreement to configure and manage the storage associated with the logical unit. In an embodiment within a complex datacenter environment, a wide range of storage devices may be available to the storage manager 102 for storing the various images. A storage manager 102 may select a set of storage devices when configuring a logical unit, then cause the base image and differencing image to be created on the various devices.

During operation, the storage manager 102 may monitor the performance of the various storage devices to determine whether a service level agreement is being met. When the performance changes from a range defined in a service level agreement, the storage manager 102 may reconfigure the storage devices and images as appropriate to meet the service level agreement.

In a case such as embodiment 100 where logical unit 114 has service level agreement 118 and logical unit 116 has service level agreement 120, the storage manager 102 may apply two different storage level agreements. Each storage level agreement may have parameters defining how a differencing image may be configured and managed. Since each differencing image may be used only by the corresponding logical unit, there may not be a conflict.

A conflict may arise when each service level agreement 118 and 120 may define different parameters for the shared base image 108. In a simple example, one service level agreement may define that the base image 108 is to be stored remotely while another service level agreement may define that the base image 108 is to have a local copy.

In the case of a conflict between service level agreements, the storage manager 102 may have heuristics, algorithms, or other logic that may define a resolution. In some cases, a conflict may be escalated to a human administrator who may evaluate the various service level agreements and determine a corrective action.

The storage management system 102 may use multiple storage devices to create and manage each of the images that make up a logical unit. Each of the operating systems 104 and 106 may interact with a logical unit as if the logical unit were a single storage device, however, the logical unit may be made up from the combination of a base image and differencing image. Further, each image may be stored on multiple devices.

In some embodiments, a single image may be stored on block extents gathered from multiple devices. For example, a first portion of an image may be stored on one block extent on a first device and a second portion of the image may be stored on a second block extent on a second device. In such a manner, an image may be spread across multiple devices.

In many embodiments, a service level agreement may define that an image or parts of an image may be stored on multiple devices for redundancy or other reasons. In such embodiments, each image may be stored in multiple locations.

A service level agreement may define a set of performance metrics for a logical unit. In some cases, a service level agreement may define alternative configurations when one or more performance metrics are not being met. For example, when a remote device is not able to meet a service level agreement for synchronized write operations, the logical unit or image may be reconfigured so that the remote device operates with asynchronous write operations while two or more other local devices operate with synchronous write operations.

Prior to creating a logical unit, the storage manager 102 may take an inventory of available storage devices and store descriptors of the storage devices in a device database. The inventory may include static descriptors of the various devices, including network address, physical location, available storage capacity, model number, interface type, and other descriptors.

The inventory may also include dynamic descriptors that define maximum and measured performance. The storage manager 102 may perform tests against a storage device to measure read and write performance, which may include latency, burst and saturated throughput, and other metrics. In some embodiments, the storage manager 102 may measure dynamic descriptors over time to determine when a service level agreement may not be met or to identify a change in a network or device configuration.

The block level management of an image may enable the storage manager 102 to treat each block of data separately. For example, some blocks of a difference image may be accessed frequently while other blocks may not. The frequently accessed blocks may be placed on a storage device that offers increased performance, such as a local flash memory device, while other blocks may be placed on a device that offers poorer performance but may be operated at a lower cost.

The storage manager 102 may create and manage a differencing image to meet criteria defined in a service level agreement. The service level agreement may define a size for the differencing image or base image, number of replications of blocks of data, and various performance characteristics of the image.

The size of a differencing image may be defined using thin or thick provisioning. In a thick provisioned logical unit, all of the storage requested for the image may be provisioned and assigned to the image. In a thin provisioned image, the maximum size of the image may be defined, but the physical storage may not be assigned to the image until requested.

In a thin provisioned image, the storage manager 102 may assign additional blocks of storage to the image over time. When the amount of storage actually being used grows to be close to the physical storage assigned, the storage manager 102 may identify additional storage for the image. The additional storage may be selected to comply with the storage level agreement.

The number of replications of blocks of data may define how many different devices may store each block, as well as what type of devices. The replications may be used for fault tolerance as well as for performance characteristics.

Replications may be defined for fault tolerance by selecting a number of devices that store a block so that if one of the devices were to fail, the block may be retrieved from one of the remaining devices. In some embodiments, a replication policy may define that a local copy and a remote copy may be kept for each block. Such a policy may ensure that if the local device were compromised or failed, that the data may be recreated from the remote storage devices. In some policies, such remote devices may be defined to be another device within the same or different rack in a datacenter, for example. In some cases, a replication policy may define that an off premises storage device be included in the replication.

The replications may define whether a write operation may be performed in a synchronous or asynchronous manner. In an asynchronous write operation, the write operation may complete on one device, then the storage manager 102 may propagate the write operations to another device. When an off premises or other remote storage is used, some replication policies may permit the remote storage to be updated asynchronously, while writing synchronously to multiple local devices.

Replications may be defined for performance by selecting multiple devices that may support striping. Striping read operations may involve reading from multiple devices simultaneously, where each read operation may read a different block or different areas of a single block. As all of the data are read, the various portions of data may be concatenated and transmitted to an operating system. Striping may increase read performance by a factor of the number of devices allocated to the striping operation.

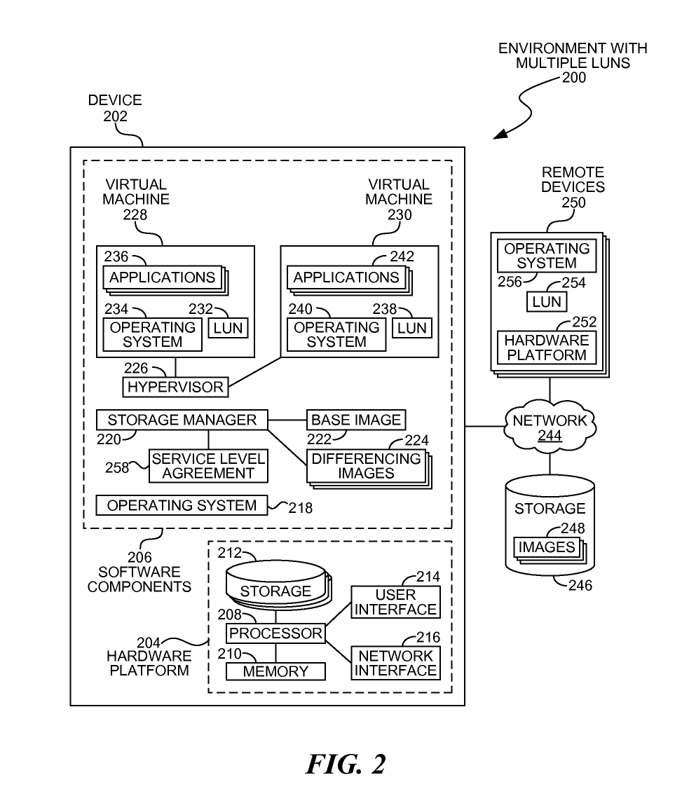

FIG. 2 is a diagram of an embodiment 200 showing a computer system with a storage management system that may use a base image and multiple differencing images to create logical units for multiple devices, including virtual machines and remote devices.

The diagram of FIG. 2 illustrates functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 may illustrate an example of a network environment in which a storage manager may manage storage for multiple devices using a common base image. The base image may be a read only image that contains a portion of a logical unit. As changes are made to the logical unit by a device using the logical unit, the changes may be stored in a differencing image.

The storage manager may configure multiple logical units, each having its own differencing image. The combination of a base image and a differencing image may represent a complete logical unit.

Embodiment 200 illustrates a device 202 that may have a hardware platform 204 and various software components 206. The device 202 as illustrated represents a conventional computing device, although other embodiments may have different configurations, architectures, or components.

In many embodiments, the device 202 may be a server computer. In some embodiments, the device 202 may still also be a desktop computer, laptop computer, netbook computer, tablet or slate computer, wireless handset, cellular telephone, game console or any other type of computing device.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 on which many applications may execute.

One such application may be a storage manager 220. The storage manager may create and manage logical units that may be presented to various devices, which may be virtual machines or other physical devices.

In some embodiments, the storage manager may be a low level service that may manage a logical unit presented to the operating system of the device on which the storage manager operates. In such embodiments, the storage manager may have an agent or low level service that operates below the operating system layer.

The storage manager 220 may manage a base image 222 and various differencing images 224 to create logical units. The storage manager 220 may operate using a service level agreement 258. Some embodiments may have a single service level agreement 258 that may apply to all logical units. In other embodiments, such as embodiment 100, each logical unit may have an independent service level agreement.

A hypervisor 226 may host various virtual machines 228 and 230. The hypervisor 226 may provide a logical unit 232 to virtual machine 228 and a logical unit 238 to virtual machine 230. The logical units may be created from the base image 222 and a differencing image 224 and managed by the storage manager 220.

Virtual machine 228 may use a logical unit 232 accessed by a guest operating system 234. Various applications 236 may operate on top of the guest operating system 234. Similarly, virtual machine 230 may use a logical unit 238 accessed by a guest operating system 240 on which various applications 242 may operate.

As each application operates and interacts with its respective logical unit, write operations may be captured and stored in a differencing image. Read operations may be processed by either a base image or a differencing image, depending on whether the block requested had been modified. Modified blocks may be processed from the differencing image, while unmodified blocks may be processed from the base image.

The storage manager 220 may operate across a network 244. In such embodiments, the storage manager 220 may use storage 246 available across the network 244 on which to store images 248 or portions of images. In some embodiments, the storage manager 220 may store portions of images on block extents that may be located on various devices. In such embodiments, a single image may be stored on several devices by storing a portion of the image on block extents on each device.

The storage manager 220 may provide logical units that may be consumed by remote devices 250. The remote devices 250 may be physical devices or virtual machines that may be hosted by various physical devices attached to the network 244.

The remote devices 250 may have a hardware platform 252 and an operating system 256. The operating system 256 may recognize a logical unit 254 that may be provided and managed by the storage manager 220 on device 202.

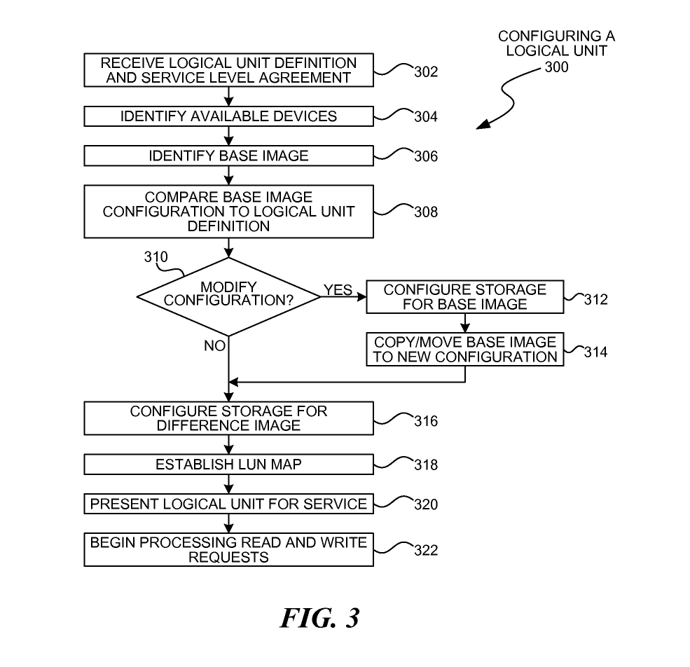

FIG. 3 is a flowchart illustration of an embodiment 300 showing a method for configuring a logical unit. Embodiment 300 may be one example of a method performed by a storage manager when creating a new logical unit from an existing base image.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

In block 302, a logical unit definition and service level agreement may be received. The logical unit definition may identify a base image for the logical unit, as well as the intended recipient or consumer of the logical unit. The consumer of the logical unit may be a computer system, guest operating system, or other consumer.

The service level agreement may include an overall service level agreement that may define performance metrics, configuration parameters, or other definitions that may enable a storage manager to configure, provide, and manage a logical unit. Some embodiments may have a service level agreement that may also include separate definitions or parameters for a base image and a differencing image.

The storage manager may identify available storage devices in block 304. The storage devices may be any device that may have storage manageable by the storage manager. In many embodiments, various storage devices in a network may have some or all of the available storage allocated to a storage manager. The devices may be configured with block extents that may be allocated to different logical units as defined by the storage manager.

In block 306, a base image may be identified. The current base image configuration may be compared to the logical unit definition and service level agreement in block 308. In many cases, a base image may be preexisting within a network environment and may be operating as part of other logical units. The comparison in block 308 may determine if the current configuration meets or exceeds the configuration that may be defined in the logical unit definition and service level agreements received in block 302.

If the configuration may be modified in block 310, storage for the base image may be configured in block 312 and the base image may be moved or copied in block 314 to the new configuration.

The storage for the differencing image may be configured in block 316.

A logical unit map may be defined in block 318. The logical unit map may be metadata or other information that may identify which blocks in a logical unit have been modified from the base image. The logical unit map may be a high speed lookup database that may be consulted for each read operation and updated with each write operation.

The logical unit may be presented for service in block 320 and read and write requests may be processed in block 322.

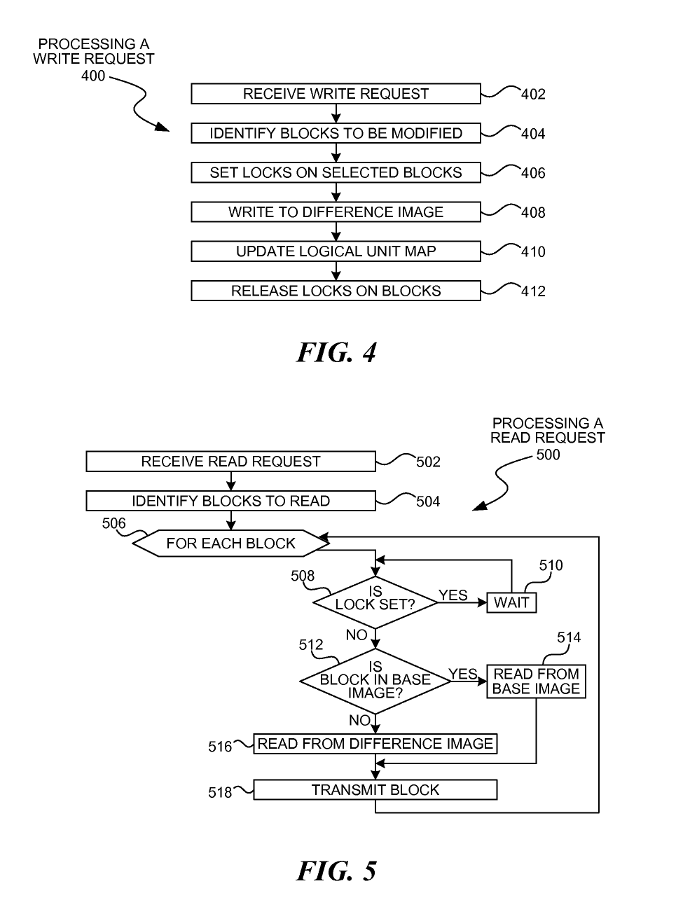

FIG. 4 is a flowchart illustration of an embodiment 400 showing a method for processing a write request. Embodiment 400 may be one example of a method performed by a storage manager when receiving new data that may be stored in a logical unit.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

In block 402, a write request may be received. The write request may include blocks to be modified, along with the data to write to the blocks.

The blocks may be identified in block 404 and locks may be placed on the blocks in block 406. The locks may prevent read operations from accessing the blocks during a write operation. Once the locks are removed later in the process, any pending read requests may be serviced.

The changes to the logical unit may be written to the difference image in block 408. The logical unit map may be updated in block 410 and the locks may be released in block 412.

FIG. 5 is a flowchart illustration of an embodiment 500 showing a method for processing a read request. Embodiment 400 may be one example of a method performed by a storage manager when receiving a read request.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

A read request may be received in block 502. The blocks to be read may be identified in block 504.

Each block may be processed individually in block 506. In the example of embodiment 500, each block may be processed sequentially. However, other embodiments may process multiple blocks in parallel.

For each block in block 506, if a lock is set on the block in block 508, a wait loop in block 510 may be processed until the lock has been released.

After the lock is released, if the block is in the base image in block 512, the block may be read in block 514. If the requested block is in the differencing image in block 512, the block may be read from the differencing image in block 516.

The block may be transmitted in block 518 and the process may be repeated in block 506 for each requested block.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed on a computer processor, said method comprising:
receiving a first logical unit definition;
configuring a first plurality of storage devices as a first logical unit in compliance with said first logical unit definition;
creating a base image and a first differencing image for said first logical unit;
presenting said first logical unit to a first operating system;
receiving a first write request from said first operating system, said write request comprising a changed first block; and
storing said changed first block in said first differencing image and updating first logical unit metadata, said first logical unit metadata identifying said first block as being modified in said first logical unit.

2. The method of claim 1 further comprising:
receiving a first read request for said first block;
determining from said logical unit metadata that said first block has been changed from said base image; and
retrieving said first block from said differencing image in response to said first read request.

3. The method of claim 2 further comprising:
receiving a second read request for a second block;
determining from said logical unit metadata that said second block has not been changed from said base image; and
retrieving said second block from said base image in response to said second read request.

4. The method of claim 3, said write request originating from an application executing within said operating system.

5. The method of claim 3, said operating system being a guest virtual machine operating system in a hypervisor environment.

6. The method of claim 3 further comprising:
receiving a second logical unit definition;
configuring a second plurality of storage devices as a second logical unit in compliance with said second logical unit definition, said second logical unit using said base image and having a second differencing image;
presenting said second logical unit to a second operating system;
receiving a second write request from said second operating system, said second write request comprising a changed third block; and
storing said changed third block in said second differencing image and updating second logical unit metadata, said second logical unit metadata identifying said third block as being modified in said second logical unit.

7. The method of claim 6, said second plurality of storage devices sharing at least one common device with said first plurality of storage devices.

8. The method of claim 7, said at least one common device storing at least one copy of said base image.

9. The method of claim 8:
said first operating system being a first guest operating system on a hypervisor;
and said second operating system being a second guest operating system on a hypervisor.

10. The method of claim 1, said first logical unit being stored on block extents within said storage devices.

11. The method of claim 1, said first logical unit being operated to comply with a service level agreement.

12. The method of claim 11, said service level agreement defining a replication number for said differencing image.

13. The method of claim 1, said first operating system being a host operating system.

14. A system comprising:
a processor;
a plurality of storage devices;
a first operating system stored on a first logical unit;
a storage manager that:
configures a first plurality of storage devices as said first logical unit;
creates a base image and a first differencing image for said first logical unit;
presents said first logical unit to said first operating system;
receives a write request from said first operating system, said first write request comprising a changed first block; and
stores said changed first block in said first differencing image and updating first logical unit metadata, said first logical unit metadata identifying said first block as being modified in said first logical unit.

15. The system of claim 14 further comprising:
a second operating system;
said storage manager that further:
configures a second plurality of storage devices as said second logical unit, said second logical unit using said base image and a second differencing image;
presents said second logical unit to said second operating system;
receives a second write request from said second operating system, said second write request comprising a changed second block; and
stores said changed second block in said second differencing image and updating second logical unit metadata, said second logical unit metadata identifying said second block as being modified in said second logical unit.

16. The system of claim 15, said first operating system being a guest operating system and said second operating system being a guest operating system.

17. The system of claim 15, said first operating system being a host operating system and said second operating system being a guest operating system.
